(19) United States
(12) Patent Application Publication
(10) Pub. No.: US 2009/0184970 A1
(43) Pub. Date: Jul. 23, 2009

(54) METHOD AND APPARATUS FOR DISPLAYING THE LASER CONTENTS

(76) Inventors: Ye-Sun Joung, Daejeon-city (KR); Won-Sik Cheong, Daejeon-city (KR); Jihun Cha, Daejeon-city (KR); Kyung-Ae Moon, Daejeon-city (KR); Jin-Woo Hong, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 12/373,163

(22) PCT Filed: Jul. 11, 2007
(86) PCT No.: PCT/KR2007/003367

§ 371 Date: Jan. 9, 2009

(30) Foreign Application Priority Data
Jul. 11, 2006 (KR) 10-2006-0065073
Jul. 11, 2007 (KR) 10-2007-0069713

(51) Int. Cl. G06T 1/00

(52) U.S. Cl. 345/522

(57) ABSTRACT

Provided are a method and apparatus for displaying lightweight applications scene representation (LASeR) content. A LASeR markup language (ML) that is based on a LASeR binary stream or a LASeR extensible markup language (XML) is parsed so as to generate a LASeR document object model (DOM). A LASeR application program interface (API) is used to generate a LASeR DOM object tree. A LASeR player accesses the LASeR DOM to display LASeR DOM scene information.

### TECHNICAL FIELD

The present invention relates to a method and apparatus for displaying lightweight applications scene representation (LASeR) content, and more particularly, to a method and apparatus for delivering rich media services using a multimedia terminal based on a LASER standard that is designed by Moving Picture Experts Group (MPEG)-4 Part 20.

### BACKGROUND ART

Lightweight applications scene representation (LASeR) has been used for efficient representation of applications including maps, animations, and 2D vector graphics of multimedia content for delivering rich media services to terminals such as mobile phones suffering from resource shortages.

In order to present LASeR content in multimedia terminals, a terminal inside material structure for analyzing LASeR binary streams or LASeR extensible markup language (XML) files and efficiently delivering the analyzed LASeR content to presentation engines, and an application programming interface (API) for accessing and correcting the terminal inside material are needed.

Since the LASeR standard version 1 does not use a LASeR scene API, it is unnecessary for converting LASeR bitstreams into document object models (DOMs). However, since the LASeR standard version 2 defines the LASeR scene API, such a conversion is necessary.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an apparatus for displaying lightweight applications scene representation (LASeR) content according to an embodiment of the present invention;

FIG. 2 is a block diagram of a multimedia receiver terminal that receives and represents rich media content specified in the LASeR standard according to an embodiment of the present invention;

FIGS. 3A through 3C are images of a multimedia receiver terminal that displays LASeR content; and

FIG. 4 is a flowchart illustrating a method of displaying LASeR content according to an embodiment of the present invention.

### DETAILED DESCRIPTION OF THE INVENTION

### Technical Goal of the Invention

The present invention provides a method and apparatus for efficiently displaying lightweight applications scene representation (LASeR) content.

### Disclosure of the Invention

According to an aspect of the present invention, there is provided an apparatus for displaying lightweight applications scene representation (LASeR) content, the apparatus comprising: a parsing unit parsing a LASeR extensible markup language (XML) or a LASeR binary stream; a LASeR document object model (DOM) converting unit converting LASeR scene information of the parsed LASeR binary stream into LASeR scene data in the form of an XML; a LASeR DOM generating unit generating a LASeR DOM based on the parsed LASeR XML or the LASeR scene data in the form of the XML converted in the LASeR DOM converting unit; and a display unit accessing the LASeR DOM using a LASeR application program interface (API) that provides content information included in the LASeR scene data and displaying a LASeR scene.

According to another aspect of the present invention, there is provided a method of displaying scene representation content, the method comprising: parsing a scene representation XML or a scene representation binary stream; converting scene information of the parsed scene representation binary stream into scene representation data in the form of an XML; generating a scene representation DOM based on the parsed scene representation XML or the converted scene representation data in the form of the XML; and accessing the scene representation DOM using an API that provides content information included in the scene representation data and displaying a scene.

### Effect of the Invention

The present invention can generate a lightweight applications scene representation (LASeR) document object model (DOM) using a LASeR scene application program interface (API) when a multimedia receiver terminal provides rich media services based on the LASeR standard specified in Moving Picture Experts Group (MPEG)-4 Part 20 and can access the LASeR DOM through the LASeR scene API, thereby more efficiently displaying LASeR content.

### BEST MODES FOR CARRYING OUT THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those of ordinary skill in the art. Like reference numerals in the drawings denote like elements. While describing the present invention, detailed descriptions about related well known functions or configurations that may cause confusion in regard to the points of the present invention, are omitted.

In the present specification, a term “lightweight applications scene representation (LASeR)” is referred to as a standard technology specified in Moving Picture Experts Group (MPEG)-4 Part 20. However, the technical feature of the present invention can be applied to all applications including maps, animations, and 2D vector graphics of mobile terminals as a method of representing a multimedia content scene in order to deliver rich media services to terminals such as mobile phones suffering from resource shortages.

Therefore, the term “LASeR” means the technology of the MPEG-4 Part 20 and simultaneously is understood as referring to a technology for a general scene description or scene representation (that is required to deliver rich media services to terminals such as mobile phones suffering from resource shortages).

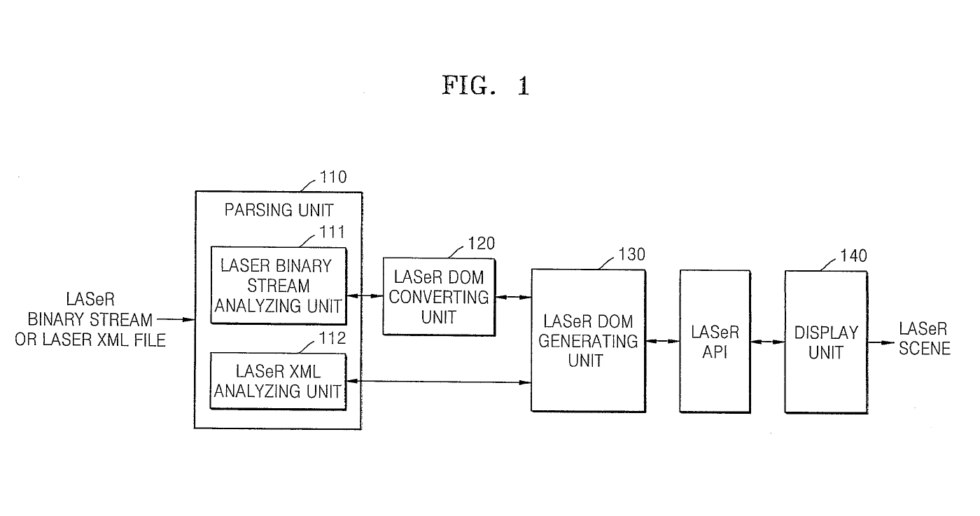

FIG. 1 is a block diagram of an apparatus for displaying LASeR content according to an embodiment of the present invention. Referring to FIG. 1, a LASeR markup language (ML) that is based on a LASeR binary stream or a LASeR extensible markup language (XML) is parsed to generate a LASeR document object model (DOM). A LASeR application program interface (API) is used to generate a LASeR DOM object tree. The LASeR DOM is accessed in a LASeR player to display LASeR DOM scene information.

The apparatus for displaying LASeR content comprises a parsing unit 110, a LASeR DOM converting unit 120, a LASeR DOM generating unit 130, and a display unit 140.

The parsing unit 110 comprises a LASeR binary stream analyzing unit 111 and a LASeR XML analyzing unit 112, parses the LASeR binary stream or the LASeR XML, and forms data that can be used in the LASeR DOM.

The LASeR binary stream analyzing unit 111 analyzes the LASeR binary stream, and delivers the LASeR binary information to the LASeR DOM converting unit 120. The LASeR DOM generating unit 130 analyzes the LASeR binary information and forms the LASeR DOM using the LASeR binary information in the form of the XML.

The LASeR XML analyzing unit 112 analyzes the LASeR XML file and delivers the LASeR XML data to the LASeR DOM generating unit 130. The LASeR DOM generating unit 130 forms the LASeR DOM based on the LASeR XML data.

The LASeR DOM converting unit 120 converts LASeR scene information of the LASeR binary stream parsed in the parsing unit 110 into LASeR scene information in the form of XML. The LASeR DOM converting unit 120 converts the LASeR binary scene information into the XML data used in the LASeR DOM.

As described in the prior art, since the LASeR standard version 1 does not use a LASeR scene API, it is unnecessary to convert the LASeR bitstream into the DOM. However, since the LASeR standard version 2 defines the LASeR scene API, it is necessary to convert the LASeR binary stream suggested in the present invention into the DOM in order to convert the LASeR binary scene information parsed in the parsing unit 110 into the XML data used in the LASeR DOM.

For example, the LASeR DOM converting unit 120 analyzes the LASeR binary bitstream indicating a circle using the parsing unit 110 and converts the LASeR binary scene information into the XML data used in the LASeR DOM.

The LASeR DOM generating unit 130 generates the LASeR DOM based on the parsed LASeR XML or the XML data converted in the LASeR DOM converting unit 120. The LASeR DOM is a LASeR inside material structure based on the DOM.

In this case, the LASeR DOM generating unit 130 generates the LASeR DOM based on the LASeR scene data analyzed in the LASeR DOM converting unit 120 or the LASeR XML analyzing unit 112 using the LASeR API.

The display unit 140 accesses the LASeR DOM using the LASeR API that provides content information included in the LASeR data such as the LASeR XML or the LASeR binary stream, and displays a LASeR scene.

In more detail, the display unit 140 acquires LASeR scene data from the LASeR DOM using the LASeR scene API and displays the LASeR scene for a user. In this regard, the LASeR interface is used to access the LASeR DOM in order to acquire information for constituting the LASeR DOM object tree.

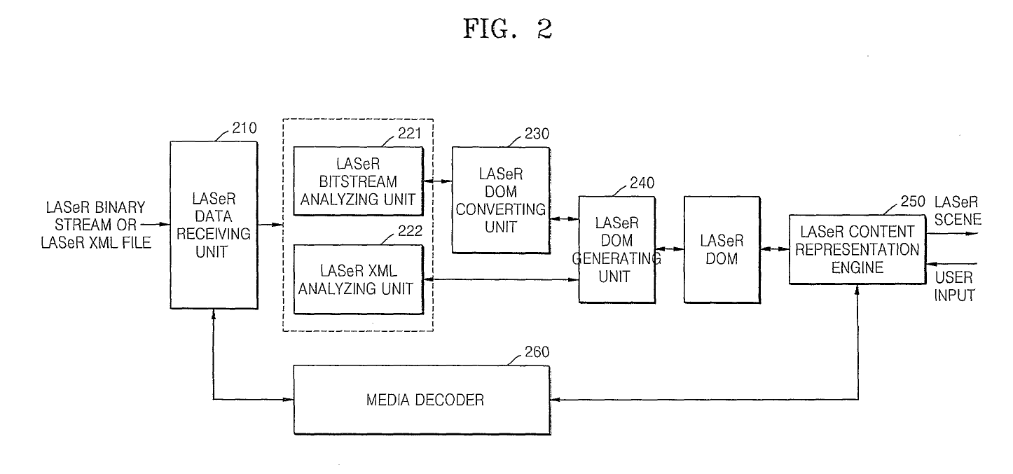

FIG. 2 is a block diagram of an apparatus for displaying LASeR content, which is realized as a multimedia receiver terminal that receives and represents rich media content specified in the LASeR standard according to an embodiment of the present invention. Referring to FIG. 2, the apparatus for displaying LASeR content comprises a LASeR data receiving unit 210, a LASeR bitstream analyzing unit 221, a LASeR XML analyzing unit 222, a LASeR DOM converting unit 230, a LASeR DOM generating unit 240, a LASeR content representation engine 250, and a media decoder 260.

The LASeR data receiving unit 210 receives a LASeR binary stream from various networks such as a mobile communication network, and a broadcast network and delivers the LASeR binary stream to the LASeR bitstream analyzing unit 221, or receives a LASeR XML file and buffers the LASeR XML file or stores it in a memory before delivering the LASeR XML file to the XML analyzing unit 222.

The LASeR bitstream analyzing unit 221 decodes the LASeR binary stream that is buffered or stored in the memory.

The XML analyzing unit 222 parses the XML file that is buffered or stored in the memory.

The LASeR DOM converting unit 230 converts the LASeR binary stream decoded in the LASeR bitstream analyzing unit 221 into XML data.

The LASeR DOM generating unit 240 generates a LASeR DOM based on the LASeR data (the decoded LASeR bitstream and/or the parsed XML file). The LASeR DOM is a LASeR inside material structure based on the DOM and includes a LASeR scene API used to access the LASeR DOM in order to acquire information on a scene representation tree constituted by the LASeR content representation engine 250.

The media decoder 260 decodes various kinds of media used in the LASeR content, e.g., video, audio, font, or metadata, and displays the media on a display device by using the LASeR content representation engine 250.

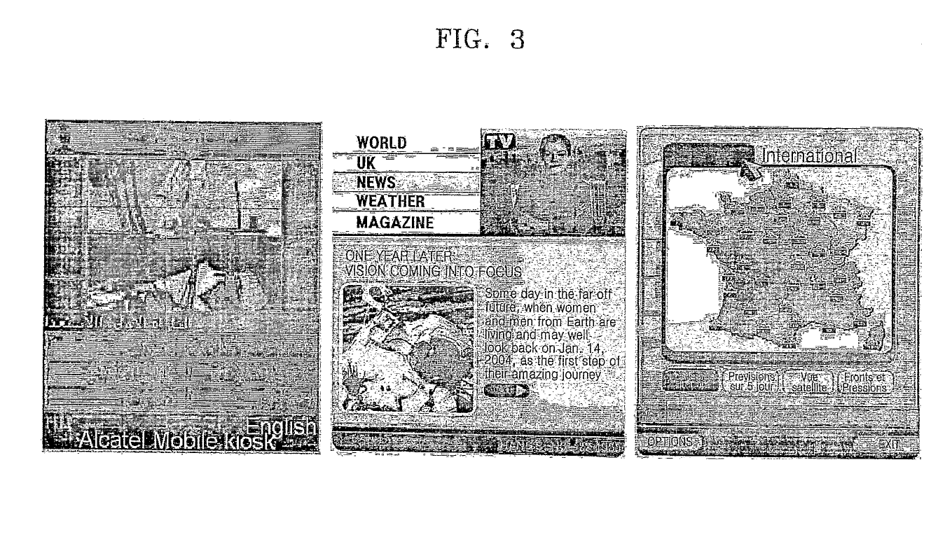

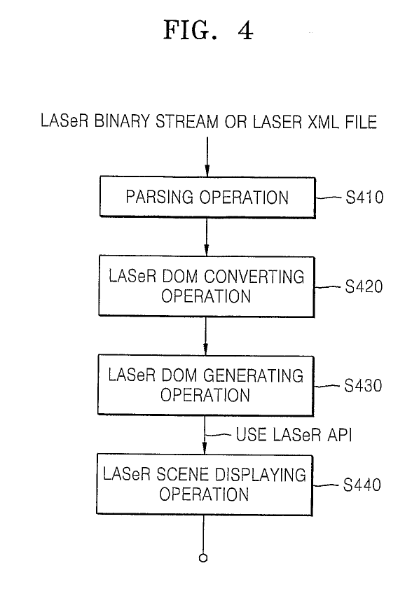

FIGS. 3A through 3C are images of a multimedia receiver terminal that displays LASeR content. FIG. 4 is a flowchart illustrating a method of displaying LASeR content according to an embodiment of the present invention. Referring to FIG. 4, the flowchart has the same or similar constitution as described in reference to FIG. 1 and thus a detailed description thereof will be omitted here.

The multimedia receiver terminal parses a LASeR XML or a LASeR binary stream in order to display the LASeR content specified in the LASeR standard of the MPEG-4 Part 20 (Operation 410).

The multimedia receiver terminal converts LASeR scene information of the parsed LASeR binary stream into XML data (Operation 420), and generates a LASeR DOM based on the converted LASeR scene data in the form of XML (Operation 430).

The multimedia receiver terminal accesses the LASeR DOM using a LASeR API that provides content information included in the LASeR scene data and displays a LASeR scene (Operation 440).

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the present invention is defined not by the detailed description of the invention but by the appended claims, and all differences within the scope of the present invention will be construed as being included in the present invention.

1. An apparatus for displaying lightweight applications scene representation (LASeR) content, the apparatus comprising:
a parsing unit parsing a LASeR extensible markup language (XML) or a LASeR binary stream;
a LASeR document object model (DOM) converting unit converting LASeR scene information of the parsed LASeR binary stream into LASeR scene data in the form of an XML;
a LASeR DOM generating unit generating a LASeR DOM based on the parsed LASeR XML or the LASeR scene data in the form of the XML converted in the LASeR DOM converting unit; and
a display unit accessing the LASeR DOM using a LASeR application program interface (API) that provides content information included in the LASeR scene data and displaying a LASeR scene.

2. The apparatus of claim 1, wherein the LASeR DOM generating unit uses the LASeR API when generating the LASeR DOM.

3. The apparatus of claim 1, wherein the display unit uses the LASeR API to constitute a LASeR DOM object tree.

4. The apparatus of claim 1, wherein the LASeR document object model is generated based on a LASeR object model.

5. A method of displaying LASeR content, the method comprising:
parsing a LASeR XML or a LASeR binary stream;
converting LASeR scene information of the parsed LASeR binary stream into LASeR scene data in the form of an XML;
generating a LASeR document object model (DOM) based on the parsed LASeR XML or the converted LASeR scene data in the form of the XML; and
accessing the LASeR DOM using a LASeR API that provides content information included in the LASeR scene data and displaying a LASeR scene.

6. The method of claim 5, wherein the LASeR API is used to generate the LASeR DOM.

7. The method of claim 5, wherein the LASeR API is used to constitute a LASeR DOM object tree.

8. The method of claim 5, wherein the LASeR document object model is generated based on a LASeR object model.

9. An apparatus for displaying scene representation content, the apparatus comprising:
a parsing unit parsing a scene representation XML or a scene representation binary stream;
a scene representation DOM converting unit converting scene information of the parsed scene representation binary stream into scene representation data in the form of an XML;
a scene representation DOM generating unit generating a scene representation DOM based on the parsed scene representation XML or the scene representation data in the form of the XML converted in the scene representation DOM converting unit; and
a display unit accessing the scene representation DOM using an API that provides content information included in the scene representation data and displaying a scene.

10. The apparatus of claim 9, wherein the scene representation DOM generating unit uses the API when generating the scene representation DOM, and the display unit uses the API to constitute a scene representation DOM object tree.

11. A method of displaying scene representation content, the method comprising:
parsing a scene representation XML or a scene representation binary stream;
converting scene information of the parsed scene representation binary stream into scene representation data in the form of an XML;
generating a scene representation DOM based on the parsed scene representation XML or the converted scene representation data in the form of the XML; and
accessing the scene representation DOM using an API that provides content information included in the scene representation data and displaying a scene.

12. The method of claim 11, wherein the API is used to generate the scene representation DOM and to constitute a scene representation DOM object tree.

13. A computer readable recording medium storing a program for executing the method of any one of claims 5 through 8.
